(19) United States
(12) Patent Application Publication
(10) Pub. No.: US 2021/0382415 A1
(43) Pub. Date: Dec. 9, 2021

(54) IMAGE FORMING APPARATUS

(71) Applicant: CANON KABUSHIKI KAISHA, Tokyo (JP)

(72) Inventors: Jun Asami, Shizuoka (JP); Masaki Shimomura, Shizuoka (JP)

(21) Appl. No.: 17/337,557

(22) Filed: Jun. 3, 2021

(30) Foreign Application Priority Data
Jun. 9, 2020 (JP) 2020-100557

(51) Int. Cl. G03G 15/16; G03G 15/09; G03G 15/01; G03G 15/00

(52) U.S. Cl. CPC G03G 15/1665; G03G 15/0935; G03G 2215/00599; G03G 15/1655; G03G 15/5008; G03G 15/0189

(57) ABSTRACT

An image forming apparatus includes an image bearing member, a transfer rotating body, a feeding means and a control means that controls a feeding speed of a recording material in a feeding portion at the feeding means. Wherein a first timing is a timing during when a rear end of the recording material with respect to a feeding direction passes through a transferring portion and a second timing is a timing when the rear end of the recording material is separated from the image bearing member after passing through the transferring portion, the control means can control the feeding means for one recording material so that a feeding speed of the recording material at the second timing in the feeding portion becomes faster than that of at the first timing in the feeding portion.

### FIELD OF THE INVENTION AND RELATED ART

The present invention relates to an image forming apparatus such as a copier, a printers and a facsimile machine that apply an electrophotographic type or an electrostatic recording type.

Conventionally, there is an image forming apparatus applying the electrophotographic type in which a toner image formed on a photosensitive drum as an image bearing member is transferred to a sheet-like recording material such as recording paper in a transferring portion. In this image forming apparatus, the toner transferred to the recording material is fixed on the recording material by heating and pressurizing it in a fixing portion. In this image forming apparatus, the recording material is fed from a recording material accommodating portion, such as a recording material cassette, by a feeding roller, etc., and is sequentially fed to the transferring portion and the fixing portion, and then discharged to the outside of the image forming apparatus. The image forming apparatus with such a configuration will be mainly described as an example in the following.

In an image forming system with said configuration, the transfer of the toner image from the photosensitive drum to the recording material is performed as follows. A transfer nip portion is formed between the photosensitive drum and a transfer roller that presses against the photosensitive drum. The recording material is fed to the transfer nip portion, and a transfer bias of an opposite polarity from a normal charge polarity of toner is applied to the transfer roller. As a result, an electric charge is applied to the recording material, and the toner image on the photosensitive drum is transferred onto the recording material.

In this configuration, if an excessive transfer current flows to a rear-end edge of the recording material, the charge becomes excessive at the rear-end edge of the recording material, and an electrical discharge may occur between the recording material and the photosensitive drum. The discharge may cause a localized drop in electric potential on the photosensitive drum, and when printing on the next recording material, an electric potential difference on the photosensitive drum could not be fully canceled by charging process, resulting in a “rear-end memory” phenomenon that appears as a thread-like image defect. In particular, burrs often exist at the edge of the recording material. When sharp edges of the burrs become starting points and an excessive transfer current flows in, an electric discharge may occur between the recording material and the photosensitive drum, causing “rear-end memory”.

Conventionally, a configuration is known in which a weak bias, which is lower than a transfer bias applied to a printable area (image area), is applied in a margin area (non-image area) at a rear-end portion of the recording material to suppress “rear-end memory” (Japan Laid-Open Patent Application (JP-A) 2002-55542).

The terms “front end” and “rear end” with respect to the recording material or the area on the recording material refer to front end and rear end of the recording material in a feeding direction, respectively.

However, process speeds of recent high-speed image forming apparatuses are getting faster and even if the configuration of JP-A 2002-55542 is applied, problems may occur such as the following. Depending on the process speed of the image forming apparatus, it may not be possible to sufficiently reduce the bias applied to the rear-end portion of the recording material to the desired weak bias. As a result, discharge may occur between the recording material and the photosensitive drum by an excess of electric charge at the rear-end portion of the recording material and “rear-end memory” may be generated.

### SUMMARY OF THE INVENTION

An object of the present invention is to suppress the occurrence of the rear-end memory of the image bearing member when the rear-end portion of the recording material passes through the transferring portion, regardless of the process speed of the image forming apparatus.

According to a first aspect of the disclosure, an image forming apparatus comprising: a rotatable image bearing member configured to bear a toner image; a rotatable transfer member configured to form a transferring portion for transferring the toner image from said image bearing member to a recording material in contact with said image bearing member, and to nip the recording material between itself and said image bearing member at said transfer member; a feeding unit provided with a feeding portion configured to nip and feed the recording member in a downstream of said transferring portion with respect to a feeding direction of the recording material, said feeding unit being capable of feeding the recording material nipped by both said transferring portion and said transferring portion in a state in which a deflection of the recording material convexly protruding toward an opposite side of said image bearing member is formed between said transferring portion and said feeding portion; and a control portion configured to control a feeding speed of the recording material at said feeding portion of said feeding unit, wherein when a first timing is a timing during when a rear end of the recording material with respect to the feeding direction passes through said transferring portion and a second timing is a timing when the rear end of the recording material is separated from said image bearing member after passing through said transferring portion, said control portion controls said feeding unit for one recording material so that a feeding speed of the recording material at the second timing in said feeding portion becomes faster than that of at the first timing in said feeding portion.

Further features of the present invention will become apparent from the following description of exemplary embodiments (with reference to the attached drawings).

### BRIEF DESCRIPTION OF THE DRAWINGS

FIG. 1 is a schematic sectional view showing an image forming apparatus.

FIG. 2 is a schematic block diagram showing control aspects of main parts of an image forming apparatus.

FIG. 3 is a schematic view showing a printable area and a margin area on a recording material.

FIG. 4 is a chart and a schematic view illustrating a transfer bias control.

FIG. 5 is a schematic sectional view showing a configuration between a transferring portion and a fixing portion (a feeding portion).

FIG. 6 is a timing chart showing a rotational speed control of a fixing motor in the first embodiment of the present invention.

FIG. 7 is a schematic sectional view illustrating a separation timing.

FIG. 8 is a timing chart comparing the first embodiment with the comparison examples 1 and 2.

FIG. 9 is a schematic sectional view illustrating an effect of the first embodiment on rear-end memory.

FIG. 10 is a schematic sectional view illustrating a behavior of a recording material at timing t3 in the first embodiment, the comparison example 1 and the comparison example 2.

FIG. 11 is a timing chart comparing the second embodiment with the first embodiment.

FIG. 12 is a schematic sectional view illustrating a behavior of a recording material at timing t5 in the second embodiment and the first embodiment.

FIG. 13 is a schematic sectional view illustrating an effect of the second embodiment on rear-end memory.

FIG. 14 is a schematic sectional view illustrating a behavior of a recording material at timing t3 in the second embodiment and the first embodiment.

### DESCRIPTION OF EMBODIMENTS

The image forming apparatus of the present invention will be described in more detail below in accordance with the drawings.

### First Embodiment

### (1) Overall Configuration and Operation of an Image Forming Apparatus

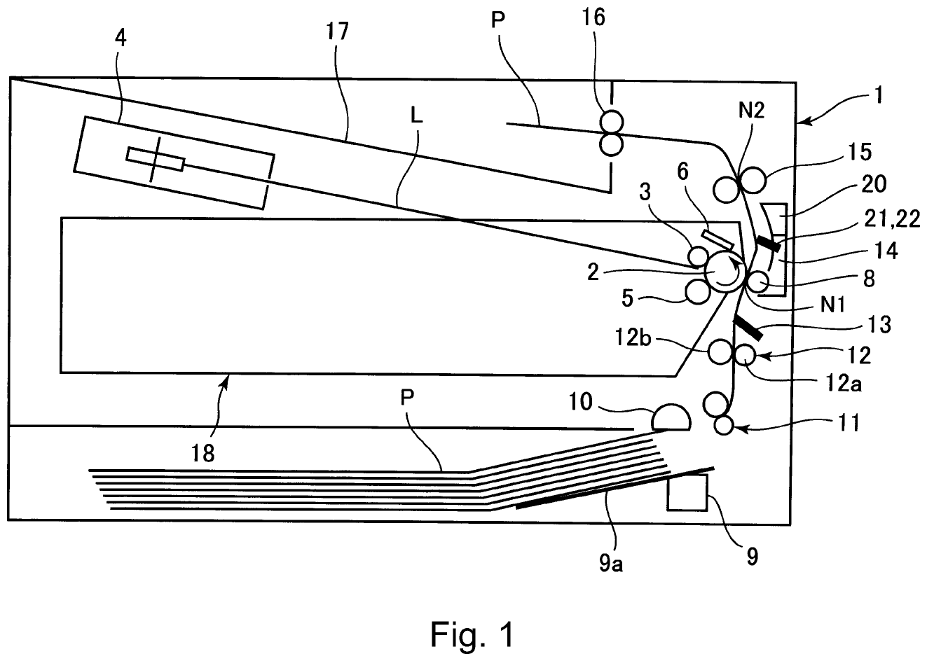

FIG. 1 is a schematic sectional view (a sectional surface perpendicular to a rotational axis a photosensitive drum 2) showing an image forming apparatus 1 in this embodiment. The image forming apparatus 1 in this embodiment is a laser printer of an electrophotographic type. The image forming apparatus 1 forms an image on a recording material P in accordance with an image information input from an external device (unshown) such as a host computer.

The image forming apparatus 1 has a photosensitive drum 2, which is a rotatable drum-shaped (cylindrical) electrophotographic photosensitive member (photosensitive member) as an image bearing member. When a print command is input to the image forming apparatus 1 from an external device, the photosensitive drum 2 is rotated in the direction of the arrow (counterclockwise) in FIG. 1 at a predetermined peripheral speed. In this embodiment, the peripheral speed of the photosensitive drum 2 corresponds to the process speed of the image forming apparatus 1. In this embodiment, the photosensitive drum 2 is an OPC photosensitive drum with an outer diameter of 30 mm, in which an OPC (Organic Photoconductor) layer having a CT layer (Charge Transfer Layer) mainly consisting of a polycarbonate binder is formed on an aluminum cylinder.

The surface (outer peripheral surface) of the rotatable photosensitive drum 2 is uniformly charged to a predetermined potential of a predetermined polarity (negative polarity in this embodiment) by a charging roller 3 as a charging means. In this embodiment, the charging roller 3 is a single-layer structure consisting of a conductive core metal surrounded by a conductive elastic layer. Both ends of this conductive core metal are pressed toward the photosensitive drum 2 by an unshown pressing means, and the charging roller 3 rotates accompanying the rotation of the photosensitive drum 2. An unshown charging bias power supply (high-voltage power supply circuit) is electrically connected to the conductive core metal of the charging roller 3. During the charging process, a predetermined charging bias (charging voltage) is applied to the charging roller 3 by the charging bias power supply.

The surface of the charged photosensitive drum 2 is scanned according to an image information by an exposure device (laser scanner) 4 as an exposing means, and an electrostatic latent image (electrostatic image) according to the image information is formed on the photosensitive drum 2. The exposure device 4 outputs a laser beam L modulated according to a time-series electric digital pixel signal of the image information input to the image forming apparatus 1 from an external device, and scans the charged surface of the photosensitive drum 2 with the laser beam L.

The electrostatic latent image formed on the photosensitive drum 2 is developed (visualized) after toner as developer is supplied by a developing device 5 as a developing means, and a toner image (developed image) is formed on the photosensitive drum 2. In this embodiment, toner charged with the same polarity as the photoreceptor drum 2 (negative polarity in the embodiment) is attached to an exposed area (image area) on the photoreceptor drum 2, where an absolute value of an electric potential has been reduced by exposure after being uniformly charged (reverse developing method). In this embodiment, the normal charging polarity of toner as the charging polarity of toner at the time of developing, is negative.

A transfer roller 8, which is a roller-shaped transfer member (transfer rotatable member) as a transfer means, is arranged opposite the photosensitive drum 2. The transfer roller 8 is pressed toward the photosensitive drum 2 by an unshown pressing means to form a transferring nip portion (transferring portion) N1 between the photosensitive drum 2 and the transferring roller 8. The toner image formed on the photosensitive drum 2 is sent to the transferring nip portion N1 by the rotation of the photosensitive drum 2. In this embodiment, the photosensitive drum 2, the charging roller 3, the exposure device 4 and the developing device 5 constitute the image forming portion that forms a toner image on the recording material P.

On the other hand, a sheet-shaped recording material (a transfer material, a sheet) P, such as a recording paper, is loaded on a sheet loading base 9a of a recording material cassette 9 as a recording material accommodating portion. The recording material P is picked up and fed one by one by a feeding roller 10 as a feeding member driven at a predetermined control timing, and is fed to a registration portion 12 by a transport roller pair 11 as a transport member. The registration portion 12 includes a registration roller 12a as a feeding member and a roller 12b which contacts the registration roller 12a. The registration portion 12 stops the recording material P by receiving a tip of the recording material P at a registration nip portion between the registration roller 12a and the roller 12b, and corrects a skew of the recording material P. In a vicinity of the registration portion 12, a registration sensor 13 as a recording material detecting means to detect the recording material P is disposed. In this embodiment, the registration sensor 13 detects a passing timing (or an arriving timing) of a front end and a rear end of the recording material P, and the length of the recording material P in a feeding direction. The recording material P is fed from the registration portion 12 to the transferring nip portion N1 by driving the resist roller 12a, and is timed with the toner image on the photosensitive drum 2 to be supplied to the transferring nip portion N1.

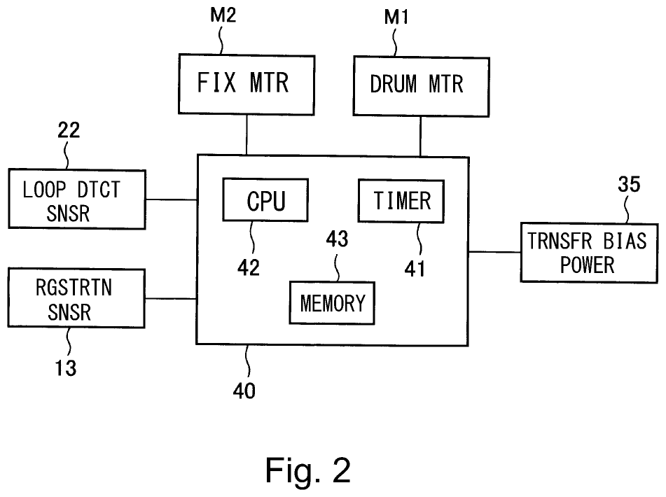

The recording material P supplied to the transferring nip portion N1 is nipped and fed by the photosensitive drum 2 and the transferring roller 8. In this embodiment, the transferring roller 8 is an elastic roller with an outer diameter of 14 mm, in which an elastic layer consisting of a sponge made of NBR (Nitrile Butadiene Rubber), epichlorohydrin rubber, etc. with a wall thickness of 4.5 mm is formed around a core metal made of stainless steel with an outer diameter of 5 mm. In this embodiment, an electrical resistance value of the transferring roller 8 is approximately 5.0×10⁷Ω. This electrical resistance value is calculated from an electric current value which is measured when the transferring roller 8 is rotating at a rim speed of approximately 120 mm/sec with the transferring roller 8 pressed against a grounded aluminum drum at a 400 g load under normal temperature and humidity, and applying a voltage of 2.0 KV to the core metal. A transfer bias power supply (high-voltage power supply circuit) 35 (FIG. 2) is electrically connected to the core metal of the transferring roller 8. During a transfer process, the transfer bias power supply 35 applies a predetermined transfer bias (transfer voltage), which is a DC voltage of an opposite polarity to a normal charging polarity of toner, to the transferring roller 8. In this embodiment, a transfer bias is under a constant voltage control. Accordingly, a toner image on the photosensitive drum 2 is transferred to the recording material P in a process of the recording material P being fed through the transferring nip portion N1.

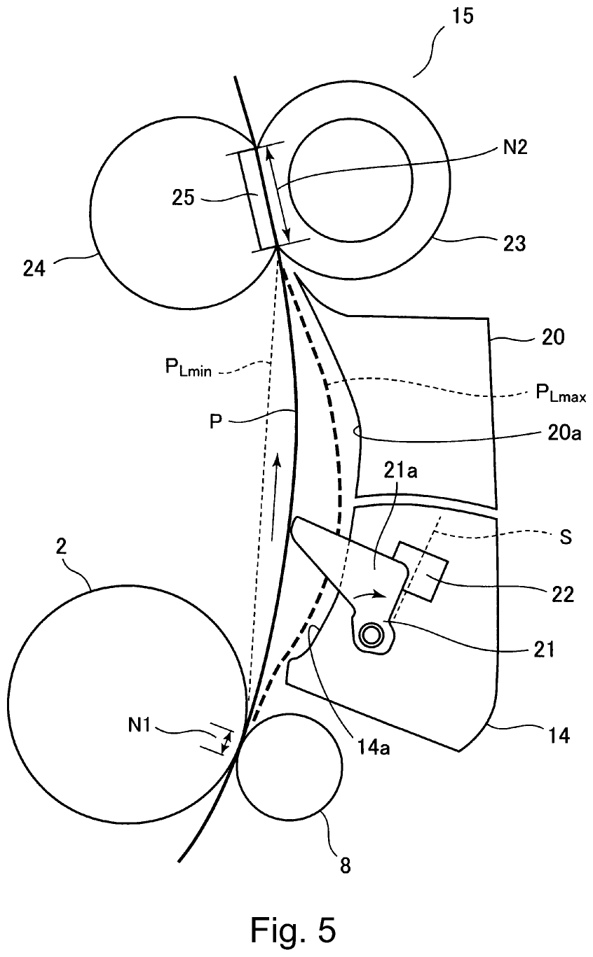

The recording material P separated from a surface of the photosensitive drum 2 is fed to a fixing device 15 as a fixing means along a feeding guide 14 and a fixing entrance guide 20 as a guide member. The fixing device 15 heats and pressurizes the recording material P which bears an unfixed toner image to fix (melt, adhere) the toner image on the recording material P. In a fixing nip portion N2 between a fixing film 24 in FIG. 5 and a pressure roller 23 in FIG. 5 to be described later which are included in the fixing device 15, the recording material P, which bears the unfixed toner image, is nipped and fed between the fixing film 24 and the pressure roller 23. After passing through the fixing nip portion N2 and the toner image has been fixed, the recording material P is then discharged (output) by a discharge roller pair 16 as a discharge member onto a discharge tray 17 as a discharge portion provided outside the image forming apparatus 1.

A toner remaining (transfer residual toner) on a surface of the photosensitive drum 2 after the recording material P is separated is removed from the surface of the photosensitive drum 2 by a cleaning device 6 as a cleaning means and collected.

In this embodiment, the photosensitive drum 2, and the charging roller 3, the developing device 5 and the cleaning device 6 as process means acting on the photosensitive drum 2 constitute a process cartridge 18 which is integrally detachable from a main assembly of the image forming apparatus 1.

The image forming system 1 in this embodiment has a print speed of 75 sheets per minute (LTR) and a process speed of approximately 400 mm/sec.

### (2) Control Aspect

FIG. 2 is a schematic block diagram showing control aspects of main parts of the image forming apparatus 1 in this embodiment. FIG. 2 shows a control system mainly related to a transfer bias control and a loop control which will be described later.

A control means 40 provided in the image forming apparatus 1 includes a timer 41, a CPU 42, a memory 43 and an input/output circuit (unshown) for controlling an input/output of signals to and from each part. A registration sensor 13, a loop detection sensor 22 to be described later, a transfer bias power supply 35, a drum motor M1 and a fixing motor M2 to be described later are connected to the control means 40.

A timer 41 as timing detection means (time measurement means) counts various timings necessary for a control of the control means 40. The CPU 42 as arithmetic control means executes various operations necessary for a control of the control means 40. A memory 43 as a memorizing means consists of ROM, RAM, etc. The ROM stores a control program, pre-determined data tables, etc. The RAM stores information input to the control means 40, detected information, calculation results, etc. Particularly in this embodiment, the memory 43 (RAM) records information necessary for control such as passage timings of front and rear edges of the recording material P detected by the registration sensor 13.

### (3) Transfer Bias Control

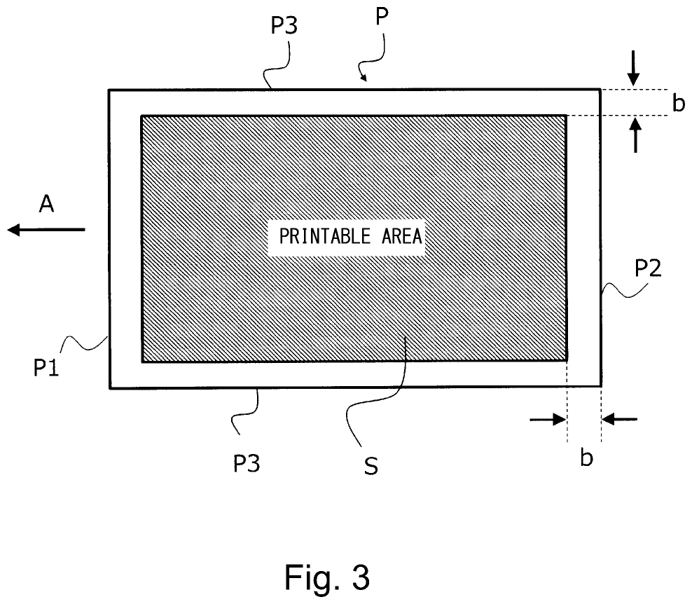

FIG. 3 is a schematic view showing a printable area and a margin area on a recording material P in this embodiment.

In this embodiment, a printable area S on the recording material P is an area inside by a distance b (example 5 mm) from a front end P1, a rear-end P2 and, a right-end and a left-end P3 when an arrow A in FIG. 3 is a feeding direction of the recording material P.

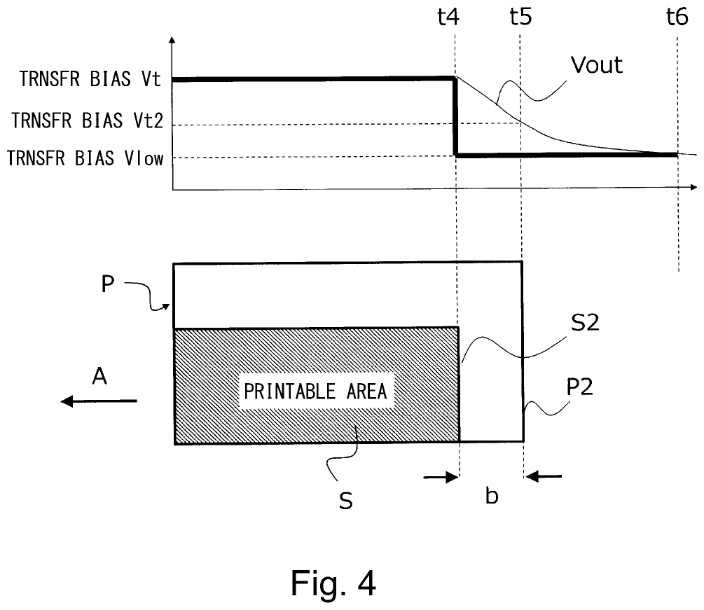

FIG. 4 illustrates a transfer bias control in this embodiment, mainly in a vicinity of the rear-end P2 of the recording material P. An upper figure of FIG. 4 is a chart diagram showing a transition of a transfer bias, where a horizontal axis indicates time (distance) and a vertical axis indicates a transfer bias. A lower figure of FIG. 4 is a schematic diagram showing an area on the recording material P at the position of the recording material P corresponding to the horizontal axis of the upper figure of FIG. 4. For convenience, a value of voltages is described as if it were compared with its absolute value.

A transfer bias Vt is a first transfer bias required to transfer a toner image. The first transfer bias Vt is applied to the transfer roller 8 from the transfer bias power supply 35 based on an instruction from the CPU 42, when the printable area S of the recording material P is passing through the transfer nip portion N1. A transfer bias Vlow is a second transfer bias required to reduce “rear end memory”. As a second transfer bias Vlow, the transfer bias power supply 35 is turned off based on an instruction from the CPU 42 starting at a transfer bias switching timing t4 or a weaker bias than the first transfer bias Vt is applied to the transferring roller 8 from the transfer bias power supply 35. A thick solid line in the upper figure of FIG. 4 is showing an indicated value (set value) of an output of the transfer bias power supply 35 input from the CPU 42 to the transfer bias power supply 35. A thin solid line of transfer bias waveform Vout in the upper figure of FIG. 4 shows a transition of an output voltage actually applied from the transfer bias power supply 35 after the timing t4.

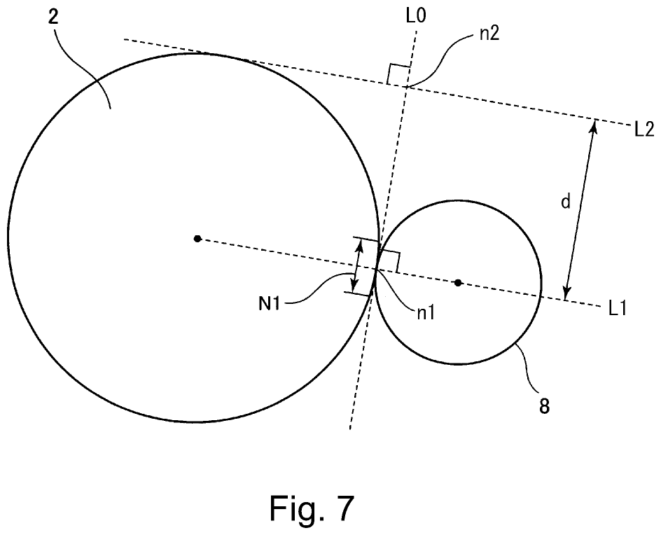

The timing t4 is a timing when the rear-end S2 of the printable area S passes through a center of the transferring nip portion N1. Timing t5 is a timing when the rear-end P2 of the recording material P passes through the center of the transferring nip portion N1. The center of the transferring nip portion N1 is a center of a width of the transferring nip portion N1 in the feeding direction of the recording material P. In this embodiment, the center of the transferring nip portion N1 is, in more detail, an intersection of a straight line connecting a rotational center of the photosensitive drum 2 and a rotational center of the transferring roller 8 in a sectional surface perpendicular to the rotational axis of the photosensitive drum 2, and a tangent line of the photosensitive drum 2 perpendicular to the straight line and passing through the transferring nip portion N1 (n1 in FIG. 7). In this embodiment, timing t4 and timing t5 are estimated by an elapsed time from a starting point, which is counted by the timer 41 starting from a timing when the rear-end P2 of the recording material P passes the registration sensor 13.

Timing t6 is a timing at which an output voltage actually applied from the transfer bias power supply 35 converges to the second transfer bias Vlow. With the transfer bias power supply 35 in this embodiment, it takes approximately 50 to 100 msec to converge the output voltage actually applied from the transfer bias power supply 35 from the first transfer bias Vt to the second transfer bias Vlow. Assuming that a distance b of a margin area is 5 mm and a process speed is 400 mm/sec, a time from timing t4 to timing t5 is approximately 12.5 msec. In this case, at timing t5 when the rear end P2 of the recording material P passes through the center n1 of the transferring nip portion N1, the output voltage actually applied from the transfer bias power supply 35 is Vt2 and has not converged to the second transfer bias Vlow.

Thus, in a configuration of this embodiment, a bias applied to the rear-end of the recording material P may not be sufficiently reduced to a desired weak bias. As a result, an electric charge may become excessive at an edge portion of the rear-end of the recording material P, resulting in a situation where “rear-end memory” is likely to occur if a feeding speed control of the recording material P described later is not executed.

In the case of a configuration in which the recording material P is fed from the transferring nip portion (transferring portion) N1 to the fixing nip portion (feeding portion) N2 from below toward above, as in the present embodiment, when the rear-end of the recording material P is separated from the photosensitive drum 2, it tends to be difficult to be separated by a weight of the recording material P. For this reason, in such a configuration, “rear-end memory” tends to occur more easily. In this embodiment, a charging bias consisting only of a DC component is applied to the charging roller 3 (DC charging). In the case of DC charging, when a charging bias including an AC component is applied, a potential leveling effect of an AC component on the photosensitive drum 2 cannot be obtained and thus “rear end memory” tends to occur more easily. In this embodiment, the image forming apparatus 1 does not include an electricity eliminating means such as a pre-exposure means that eliminate electricity (removes at least a part of an electric charge) from the photosensitive drum 2 after a transferring process and before a charging process (pre-exposure-less). In the case of the pre-exposure-less system, since an effect of resetting a surface potential of the photosensitive drum 2 after the transferring process and before the charging process is not obtained, “rear end memory” tends to occur more easily.

### (4) Transferring/Fixing Feeding Path

FIG. 5 is a sectional view (a sectional surface perpendicular to the rotational axis of the photoreceptor drum 2) showing a feeding path of the recording material P between the transferring nip portion N1 and the fixing nip portion N2. With respect to the image forming apparatus 1 or an element of the image forming apparatus 1, an up-down direction refers to an up-down direction in a direction of gravity (vertical direction), and it does not mean only directly above or below, but also includes above and below a horizontal plane passing through an element or a position of targeted.

The transferring nip portion N1 is formed between the photosensitive drum 2 and the transferring roller 8 that presses against the photosensitive drum 2. That is, a contact area between a surface (outer peripheral surface) of the photosensitive drum 2 and a surface (outer peripheral surface) of the transferring roller 8 is the transferring nip portion N1. The recording material P is nipped and fed between the photosensitive drum 2 and the transferring roller 8 in the transferring nip portion N1. In this embodiment, the recording material P is fed from below toward above in the transferring nip portion N1.

In this embodiment, the fixing device 15 includes a thin-walled endless belt-shaped fixing film 24 as a heating rotatable member (fixing rotatable member, fixing member), and a plate-shaped heater 25 that contacts an inner surface of a fixing film 24 as a heat source. The fixing device 15 also has the pressure roller 23 as a pressure rotatable member (fixing rotatable member, pressure rotatable member) that presses against the fixing film 24. In this embodiment, the heater 25 is composed of a ceramic heater. The fixing nip portion N2 is formed between the fixing film 24 and the pressure roller 23 by the heater 25 being pressed against the pressure roller 23 via the fixing film 24 with a predetermined force by an unshown pressing means. That is the contact area between the surface (outer peripheral surface) of the fixing film 24 and the surface (outer peripheral surface) of the pressure roller 23 is the fixing nip portion N2. The recording material P is nipped and fed between the fixing film 24 and the pressure roller 23 in the fixing nip portion N2. In this embodiment, the recording material P is fed from below toward above in the fixing nip portion N2.

A feeding guide 14 and a fixing entrance guide 20 are provided between the transferring nip portion N1 and the fixing nip portion N2. With respect to a feeding direction of the recording material P, the feeding guide 14 is disposed on the upstream side of the fixing entrance guide 20. The recording material P that has passed through the transferring nip portion N1 is fed along the feeding guide 14 and the fixing entrance guide 20 to the fixing nip portion N2. In this embodiment, the recording material P is nipped in the transferring nip portion N1 and the fixing nip portion N2 as described above to form a deflection (curved portion) that is convex on the opposite side of the photosensitive drum 2 when a loop is formed between the transferring nip portion N1 and the fixing nip portion N2. In this embodiment, the feeding guide 14 and the fixing entrance guide 20 have curved surface-shaped portions (feeding surfaces) 14a and 20a that are convex on the opposite side of the photosensitive drum 2 to accommodate the loop of the recording material P when it is formed between the transferring nip portion N1 and the fixing nip portion N2.

In a vicinity of the feeding surface 14a of the feeding guide 14, a loop detection flag (loop detection action portion) 21, which constitutes a loop amount detection means for detecting a loop amount of the recording material P, is provided. The loop detection flag 21 is composed of a rod-shaped member that can be swingable around one end portion (a base end portion) thereof. The loop detection flag 21 is disposed so that another end portion (a tip portion) projects from the feeding surface 14a of the feeding guide 14 to a side of the photosensitive drum 2. The loop detection flag 21 is biased by a spring member as a unshown pressing means, and rotates in an arrow direction in FIG. 5 against a force of the spring member according to a loop amount of the recording material P. Apart (light-shielding portion) 21a of the loop detection flag 21 that swings according to a loop amount blocks or opens a detection position (optical path) S of a loop detection sensor (a loop detection sensor portion) 22 that constitutes a loop amount detection means. The loop detection sensor 22 is turned on and off according to a swinging motion of the loop detection flag 22. Thus, in this embodiment, the CPU 42 can detect whether or not a loop amount of the recording material P has exceeded a predetermined value based on on/off of a signal output from the loop detection sensor 22 to the CPU 42.

A loop amount is a distance between a loop formed by the recording material P, between the transferring nip portion N1 and the fixing nip portion N2, and the transfer guide 14. If a feeding speed of the recording material P in the fixing nip portion N2 is slower than a feeding speed of the recording material P in the transferring nip portion N1, the loop amount increases. On the other hand, if a feeding speed of the recording material P in the fixing nip portion N2 is faster than a feeding speed of the recording material P in the transferring nip portion N1, the loop amount decreases. A minimum loop amount Lmin indicates a state PLmin where the recording material P is stretched in a straight line between the transferring nip portion N1 and the fixing nip portion N2. A maximum loop amount Lmax indicates a state PLmax where a loop formed by the recording material P between the transferring nip portion N1 and the fixing nip portion N2 increases and a part of the recording material P is in contact with the feeding guide 14 or the fixing entrance guide 20.

In this embodiment, a loop amount is typically controlled as described later so that a loop of the recording material P will not be in contact with the feeding surfaces 14a and 20a of the feeding guide 14 and the fixing entrance guide 20 respectively. The feeding guide 14 and the fixing entrance guide 20 guide the recording material P so that when a front end of the recording material P moves from the transferring nip portion N1 to the fixing nip portion N2, the front end of the recording material P is smoothly guided to the fixing nip portion N2.

### (5) Loop Control

A loop control in this embodiment will be described with FIG. 2 and FIG. 5.

The photosensitive drum 2 and the transferring roller 8 are driven to rotate by the drum motor M1 as a drive source that constitutes a drive means. The transferring roller 8 may be rotated in accordance with a rotation of the photosensitive drum 2 by a frictional force with the photosensitive drum 2. The pressure roller 23 of the fixing device 15 is driven to rotate by the fixing motor M2 as a driving source that constitutes a driving means. The fixing film 24 of the fixing unit 15 rotates in accordance with a rotation of the pressure roller 23 by a frictional force with the pressure roller 23. The driving of the drum motor M1 and the fixing motor M2 is controlled by the CPU 42, respectively.

The CPU 42 drives the photosensitive drum 2 and the transferring roller 8 by the drum motor M1 so that the recording material P is fed at a predetermined speed v0 (mm/s) in the transferring nip portion N1. The CPU 42 controls a feeding speed v (mm/s) of the recording material P at the fixing nip portion N2 by switching a rotational speed of the fixing motor M2 in order to maintain a loop amount of the recording material P between the transferring nip portion N1 and the fixing nip portion N2 within a predetermined range. In particular, the CPU 42 switches the rotational speed of the fixing motor M2 to either a first rotational speed R1 or a second rotational speed R2, which is slower than the first rotational speed R1, according to the detection signal of the loop detection sensor 22. In this way, the feeding speed v (mm/s) of the recording material P in the fixing nip portion N2 is controlled.

An outer diameter of the pressure roller 23 varies due to thermal expansion and individual variations in accordance with a type of recording material P, a usage situation (amount of usage) of the image forming apparatus 1 (the fixing roller 23), an environment (at least one of temperature or humidity), etc. The first rotational speed R1 of the fixing motor M2 is a rotational speed at which a feeding speed v (mm/s) of the recording material P in the fixing nip portion is faster than a feeding speed v0 (mm/s) of the recording material P in the transferring nip portion N1, taking into account a variation in an outer diameter of the pressure roller 23 affected by the various factors as previously described. A feeding speed of the recording material P at the fixing nip portion N2 is v1 (mm/s). The second rotational speed R2 of the fixing motor M2 is a rotational speed at which a feeding speed v (mm/s) of the recording material P in the fixing nip portion N2 is slower than the transport speed v0 (mm/s) of the recording material P in the transferring nip portion N1, taking into account the variation in the outer diameter of the pressure roller 23 affected by the various factors as previously described. A feeding speed of the recording material P at the fixing nip portion N2 is v2 (mm/s).

Thus, in this embodiment, a loop amount of the recording material P can be controlled by controlling a rotational speed of the fixing motor M2 to the first rotational speed R1 or the second rotational speed R2 according to a detection signal of the loop detection sensor 22.

### (6) Improvement of Separability of Rear-End of Recording Material from Photosensitive Drum

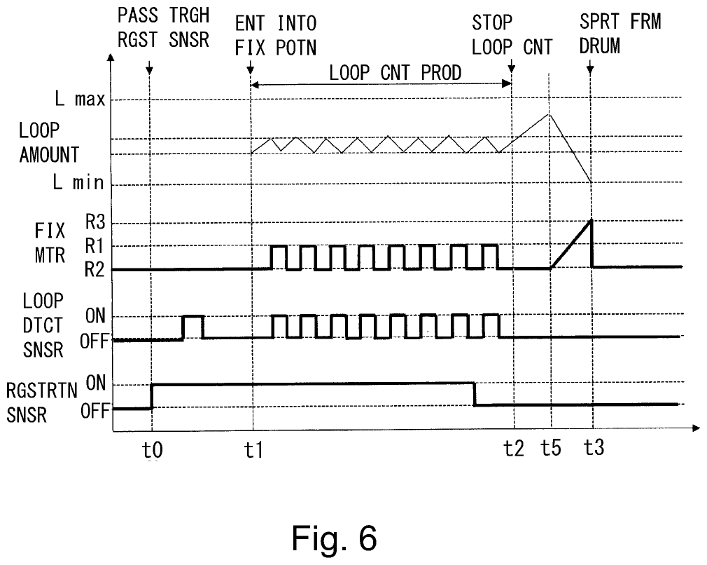

FIG. 6 is a timing chart of a switching control of a rotational speed of the fixing motor M2 in this embodiment. A flow of a switching operation of a rotational speed of the fixing motor M2 in this embodiment will be described with FIG. 6.

At timing to, the front end P1 of the recording material P passes through the registration sensor 13. At timing t1, when the front end P1 of the recording material P enters into the fixing nip portion N2, the CPU 42 starts the loop control. In this embodiment, before starting the loop control, the CPU 42 sets (fixes) a rotational speed of the fixing motor M2 to the second rotational speed R2. Immediately after the recording material P enters the fixing nip portion N2, a loop amount formed by the recording material P is small, so the loop detection flag 21 does not shade the detection position S of the loop detection sensor 22. Consequently, when the CPU 42 starts the loop control, it detects that the loop detection sensor 22 is off. Thus, the CPU 42 sets the rotational speed of the fixing motor M2 to the second rotational speed R2 in order to increase the loop amount. Since the feeding speed v2 of the recording material P in the fixing nip portion N2 at the second rotational speed R2 is slower than the feeding speed v0 of the recording material P in the transferring nip portion N1, the loop amount gradually increases.

As the loop amount increases, the loop detection flag 21 shades the detection position S of the loop detection sensor 22. Consequently, the CPU 42 detects that the loop detection sensor 22 is on. Thus, the CPU 42 switches the rotational speed of the fixing motor M2 to the first rotational speed R1 in order to decrease the loop amount. Since the feeding speed v1 of the recording material P in the fixing nip portion N2 at the first rotational speed R1 is faster than the feeding speed v0 of the recording material P in the transferring nip portion N1, the loop amount gradually decreases.

By repeating the operation as described above, the shading portion 21a of the loop detection flag 21 can be kept in a vicinity of the detection position S of the loop detection sensor 22, as shown in FIG. 6. Consequently, the loop amount of the recording material P between the transferring nip portion N1 and the fixing nip portion N2 can be maintained within a predetermined range, and the loop of the recording material P can be formed stably.

Then, based on a pass information of the front end P1 and the rear-end P2 of the recording material P by the registration sensor 13, the CPU 42 stops the loop control at the timing t2 just before the rear-end P2 of the recording material P reaches the transferring nip portion N1. In this embodiment, when the loop control is stopped, the CPU 42 sets (fixes) the rotational speed of the fixing motor M2 to the second rotational speed R2. For example, the timing t2 is the timing at which the front end of the margin area on the rear-end side of the recording material P reaches the center n1 of the transferring nip portion N1, and a distance from the rear-end of the recording material P to the center n1 of the transferring nip portion N1 is approximately from 1 mm to 10 mm.

Thereafter, the CPU 42 starts accelerating a rotational speed of the fixing motor M2 at the timing t5 when the rear end P2 of the recording material P passes through the center n1 of the transferring nip portion N1. This acceleration continues until the timing t3 when the rear end P2 of the recording material P passes through the center n1 of the transferring nip portion N1 and is separated from the photosensitive drum 2. At this time, in this embodiment, a rotational speed of the fixing motor M2 continues to accelerate without becoming constant speed or decelerating in the middle until it reaches a third rotational speed R3. This allows to have an effect of suppressing a “rear end memory” as described later. In order to maximize this effect, it is preferable to delay a start of the acceleration until the timing t5 and make a rapid acceleration of the fixing motor M2 as in this embodiment. However, even if this acceleration is started at a timing in the middle of the period from the timing t2 to the timing t5, a reasonable effect can be achieved. It is preferable that the third rotational speed R3 is as fast as possible within a range where a behavior of the recording material P is stable. As an example, in this embodiment, the third rotational speed R3 is set as follows. That is the CPU 42 calculates an average rotational speed R0 at which an average value of a feeding speed v of the recording material P in the fixing nip portion N2 is approximately equal to a feeding speed v0 of the recording material P in the transferring nip portion N1. In this embodiment, the CPU 42 calculates this average rotational speed R0 from a duty ratio of the first rotational speed R1 and the second rotational speed R2 of the fixing motor M2 in the loop control period (a period from the timing t1 to the timing t2). Then, the CPU 42 sets the third rotational speed R3 to be faster than its average rotational speed R0 by approximately +5%. In this embodiment, the third rotational speed R3 is faster than the second rotational speed R2 when the acceleration of the fixing motor M2 is started, and faster than the first rotational speed R1. Although not limited to this, from a viewpoint of suppressing “rear end memory”, it is preferable that the third rotational speed R3 is approximately +1% or more of the average rotational speed R0. Although not limited this, from a viewpoint of suppressing an enlargement of the fixing motor M3 due to an increased load, etc., it is preferable that the third rotational speed R3 is approximately +10% or less of the average rotational speed R0.

An increase or a decrease of a rotational speed of the fixing motor M2 corresponds to an increase or a decrease of a feeding speed of the recording material P in the fixing nip portion N2. That is a feeding speed of the recording material P in the fixing nip portion N2 at the timing t3 at which the rear end P2 of the recording material P is separated from the photosensitive drum 2 (the timing at which the rear end P2 of the recording material P is nipped by the transferring nip portion N1) is faster than the timing t5 at which the rear end P2 of the recording material P passes through the center n1 of the transferring nip portion N1 (the timing at which the rear end P2 of the recording material P is nipped by the transferring nip portion N1). It is preferable that a feeding speed of the recording material P in the fixing nip portion N2 at the timing t3 at which the rear end P2 of the recording material P is separated from the photosensitive drum 2 is approximately from +1% to +10% of an average value of the feeding speed of the recording material P in the fixing nip section N2 during the loop control period (the period from the timing t1 to the timing t2).

FIG. 7 is a schematic sectional view showing a vicinity of the transferring nip portion N1 (a sectional surface perpendicular to the rotational axis of the photosensitive drum 2) to illustrate the timing t3 at which the rear end P2 of the recording material P is separated from the photosensitive drum 2 as previously described. A straight line L0 is a tangent line of the photosensitive drum 2 through the transferring nip portion N1 (a tangent line of the photosensitive drum 2 that is perpendicular to a straight line L1 to be described later and that passes through the transferring nip portion N1). The straight line L1 is a line connecting a center of rotation of the photosensitive drum 2 and a center of rotation of the transferring roller 8. An intersection of the straight line L0 and the straight line L1 is a center n1 of the transferring nip portion N1. A straight line L2 is a tangent line of the photosensitive drum 2 that is parallel to the straight line L1 and disposed downstream from the transferring nip portion N1 with respect to the feeding direction of the recording material P. An intersection of the straight line L0 and the straight line L2 is a separation point n2. A distance d is a length from the center n1 of the transferring nip portion N1 to the separation point n2, and corresponds to a radius of the photosensitive drum 2.

In this embodiment, the timing t3 at which the rear end P2 of the recording material P as previously described is separated from the photosensitive drum 2 is set to a following timing as a time at which it is ensured that the rear end P2 of the recording material P is completely separated from the photosensitive drum 2. That is the timing t3 is set to the following timing as a longest time it takes for the rear end P2 of the recording material P to be separated from the photosensitive drum 2. If a process speed of the image forming apparatus 1 is X (mm/sec), it is set to be after a time d/X (sec) that it takes for the rear end P2 of the recording material P to move a distance d (mm) at the process speed X (mm/sec) from the timing t5 when the rear end P2 of the recording material P passes through the center n1 of the transferring nip portion N1. Practically, the recording material P is likely to be separated from the photosensitive drum 2 before the timing as described above. Thus, the timing t3 is not limited to the timing as described above, but may be any timing during a period from the timing t5 when the rear end P2 of the recording material P passes through the center n1 of the transferring nip portion N1 to d/X (sec) lapsed. In order to maximize an effect of suppressing “rear end memory” as described later, it is preferable to shorten a time from the timing t5 to the timing t3 to make more rapid acceleration of the fixing motor M2.

### (7) Effect of this Embodiment

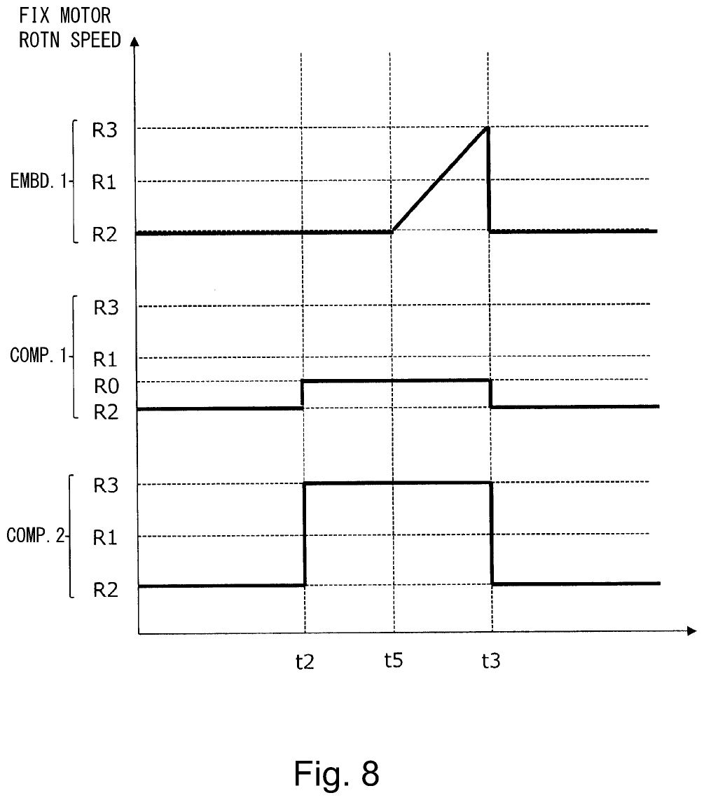

FIG. 8 is a timing chart for comparing and illustrating the rotational speed control of the fixing motor M2 in this embodiment and comparison examples. FIG. 8 shows a transition of a rotational speed of the fixing motor M2 in the period from the timing t2 to the timing t3 as described above.

As described above, in this embodiment, after the loop control is stopped at timing t2, acceleration of the rotational speed of the fixing motor M2 is started at timing t5 when the rear end P2 of the recording material P passes through the center n1 of the transferring nip section N1. This acceleration continues until timing t3, when d/X (sec) has elapsed after the rear end P2 of the recording material P passes through the center n1 of the transferring nip portion N1. In this example, at this time, the rotational speed of the fixing motor M2 continues to accelerate without becoming constant speed or decelerating in the middle until it reaches the third rotational speed R3.

In comparison example 1, after stopping the loop control at the timing t2, during the period from the timing t2 to the timing t3, a rotational speed of the fixing motor M2 is maintained at an average rotational speed R0 at which an average value of the transport speed v of the recording material P in the fixing nip portion N2 becomes approximately equal to the feeding speed v0 of the recording material P in the transferring nip portion N1. In comparison example 2, after stopping the loop control at timing t2, a rotational speed of the fixing motor M2 is accelerated at once to the third rotational speed R3 at the timing t2, and is maintained at a constant speed at the third rotational speed R3 from the timing t2 to the timing t3.

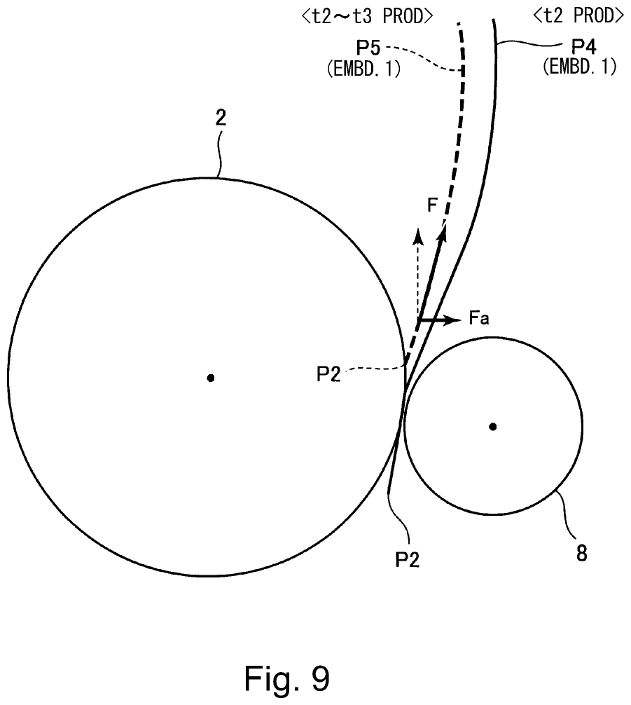

FIG. 9 is a schematic sectional view of a vicinity of the transferring nip portion N1 (a sectional surface perpendicular to the rotational axis of the photosensitive drum 2) showing an effect of this embodiment to suppress “rear end memory”. A recording material P4 shows a behavior of the recording material P at the timing t2. At this time, the loop control is stopped and the rear end P2 of the recording material P has reached before an entrance of the transferring nip portion N1. A recording material P5 shows a behavior of the recording material P in a middle of a period from the timing t2 to the timing t3. At this time, the loop of the recording material P is gradually resolved by an acceleration of the fixing motor M2, while force F due to an acceleration acts on the recording material P. And a component force Fa of the force F acts on the rear end P2 of the recording material P in a direction of quickly moving away from the photosensitive drum 2. The component force Fa is generated by a fact that the recording material P has a convex deflection on the opposite side of the photosensitive drum 2 and the acceleration of the fixing motor M2 causes the force F to act on the recording material P to resolve the deflection. An action of the component force Fa acting on the recording material P moves the rear end P2 of the recording material P, which is a starting point of discharging, away from the photosensitive drum 2. And then, frequency and degree of discharging between the rear end P2 of the recording material P and the photosensitive drum 2 are reduced and “rear end memory” is suppressed.

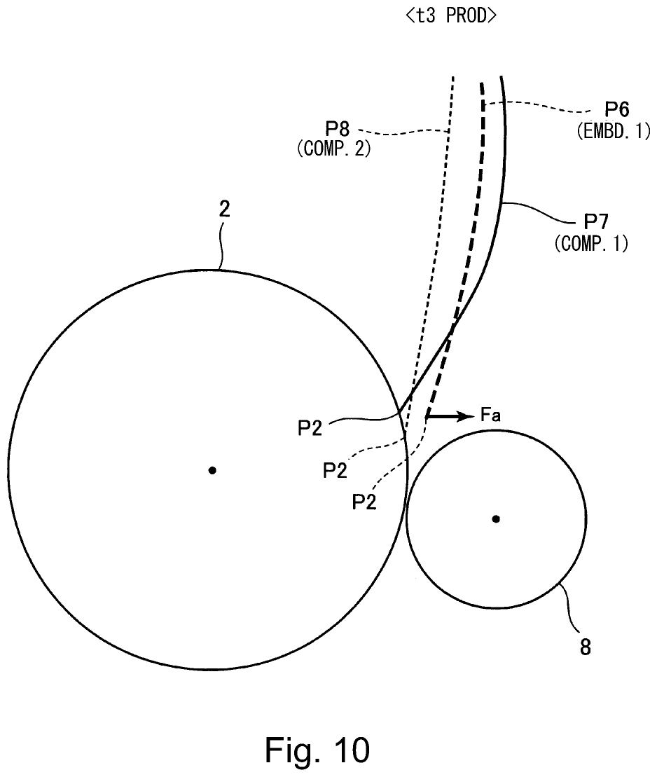

FIG. 10 is a schematic sectional view of a vicinity of the transferring nip portion N1 (sectional surface perpendicular to the rotational axis of the photosensitive drum 2) showing a behavior of the recording material P in this embodiment, comparison example 1, and comparison example 2 at the timing t3. The recording material P6 shows a behavior of the recording material P in this embodiment at the timing t3. At this time, the rear end P2 of the recording material P, which is the starting point of discharging, is kept at a distance from the photosensitive drum 2 by the action of the component force Fa as described above. A recording material P7 shows a behavior of recording material P in comparison example 1 at the timing t3. In comparison example 1, a rotational speed of the fixing motor M2 is maintained at an average rotational speed R0 during the period from the timing t2 to the timing t3. Thus, after the timing t2, the recording material P is fed while its loop is maintained to a certain extent. Then, the recording material P is separated from the photosensitive drum 2 at the timing t3 while an edge portion of the rear end P2 of the recording material P is approaching the photosensitive drum 2. Therefore, when this rear end P2 of the recording material P is in close proximity to the photosensitive drum 2, discharging between the edge portion of the rear end P2 of the recording material P and the photosensitive drum 2 is induced, and “rear end memory” is likely to occur. A recording material P8 shows a behavior of the recording material P in comparison example 2 at the timing t3. In comparison example 2, a rotational speed of the fixing motor M2 is rapidly accelerated to the third rotational speed R3 at the timing t2. Thus, after the timing t2, a loop of the recording material P8 is resolved to a certain extent before the rear end P2 reaches the transferring nip portion N1. And the recording material P is separated from the photosensitive drum 2 at the timing t3 while a vicinity of its rear end P2 of the recording material P is in close proximity to the photosensitive drum 2 on its surface. Therefore, it is not likely to induce discharging at the edge portion of the rear end P2 of the recording material P as in comparison example 1. However, when the vicinity of the rear edge P2 of the recording material P is in close proximity to the photosensitive drum 2 on its surface, if there is a sharp burr on the rear edge P2 of the recording material P, the burr becomes a starting point of discharging and “rear edge memory” is likely to occur.

Table 1 shows evaluation results of “rear end memory” in this embodiment, comparison example 1 and comparison example 2. Occurrence levels and occurrence frequencies of “rear end memory” were evaluated when continuous single-side printing was performed on A4 size plain paper (basis weight 75 g/m²) in a normal humid environment (humidity 60%). Configuration and operation of the image forming apparatus 1 of comparison example 1 and comparison example 2 are substantially the same as configuration and operation of this embodiment except that a rotational speed control of the fixing motor M2 as described above is executed. The mark o in the table 1 indicates the there is nothing in problems.

TABLE 1

| | REAR END OF RECORDING | | REAR END OF RECORDING | |
|---|---|---|---|---|
| | MATERIAL (BURR-FREE) | | MATERIAL (BURR) | |
| | OCCURRENCE | OCCURRENCE | OCCURRENCE | OCCURRENCE |
| | FREQUENCY | LEVEL | FREQUENCY | LEVEL |
| COMP. 1 | HIGH | × NOTICEABLE | HIGH | × NOTICEABLE |
| COMP. 2 | LOW | Δ FEW | HIGH | × NOTICEABLE |
| EMBD. 1 | ALMOST NOTHING | ○ | FEW | Δ VERY FEW |

In comparison example 1, the recording material P is separated from the photosensitive drum 2 while the edge portion of the rear end P2 of the recording material P is in close proximity to the photosensitive drum 2, so discharging between the edge portion of the rear end P2 of the recording material P and the photosensitive drum 2 is likely induced. Thus, in comparison example 1, occurrence frequency of “rear end memory” is high and occurrence level is unfavorable. In comparison example 2, since the recording material P is separated from the photosensitive drum 2 while a vicinity of the rear end P2 of the recording material P is in close proximity to the photosensitive drum 2 on its surface, discharging between the edge portion of the rear end P2 of the recording material P and the photosensitive drum 2 is less likely to be induced than in comparative example 1. Thus, in comparison example 2, occurrence frequency of “rear end memory” is low and level of occurrence is insignificant. However, if there is a sharp burr on the rear end P2 of the recording material P due to a cutting surface, the burr becomes a starting point of discharging and occurrence frequency of “rear edge memory” is higher and level of occurrence is worse. In contrast to the comparison examples 1 and 2, in this embodiment, the rear end P2 of the recording material P, which may be a starting point of discharging, is moved away from the photosensitive drum 2 before discharging starts at the rear end P2 of the recording material P. Therefore, in the embodiment 1, occurrence frequency of “rear end memory” is lower and level of occurrence is extremely insignificant compared to comparison example 1 and comparison example 2.

In this embodiment, the image forming apparatus 1 includes a rotatable image bearing member 2 that bears a toner image, and a rotatable transferring rotator 8 that contacts the image bearing member 2 to form a transferring portion (transferring nip portion) N1 that transfers the toner image from the image bearing member 2 to the recording material P and that nips the recording material P with the image bearing member 2 in the transferring portion N1. The image forming apparatus 1 also includes a feeding means 15 and a control means 40. The feeding means 15 is equipped with a feeding portion (a fixing nip portion) N2 that nips and feeds the recording material P downstream from the transferring portion N1 with respect to the feeding direction of the recording material P, and is capable of feeding the recording material P, which is nipped in both the transferring portion N1 and the feeding portion N2, with the recording material P forming a flexure between the transferring portion N1 and the feeding portion N2 that is convex on the opposite side of the image bearing member 2. The control means 40 controls the feeding speed of the recording material P in the feeding portion N2 by the feeding means 15. And the control means 40 with respect to one recording material P is capable of controlling the feeding means 15 so as to make the feeding speed of the recording material P at the feeding portion N2 at the second timing t3 when the rear end with respect to the feeding direction of the recording material P is separated from the image bearing member 2 after passing through the transferring portion N1 faster than the feeding speed of the recording material P at the feeding portion N2 at the first timing t5 when the rear end with respect to the feeding direction of the recording material P is passing through the transferring portion N1. In this embodiment, the first timing t5 is a timing when the rear end of the recording material P with respect to the feeding direction passes through a center of the transferring portion N1 with respect to the transport direction of the recording material P. Also, in this embodiment, the second timing t3 is a timing that elapses from the timing at which the rear end with respect to the feeding direction of the recording material P passes through the center of the transferring portion N1 with respect to the feeding direction of the recording material P by the time it takes to move the same distance as a radius of the image bearing member 2 with a cylindrical shape at the peripheral speed of the image bearing member 2. In this embodiment, the control means 40 with respect to one recording material P controls the feeding means 15 so as to continue to accelerate the feeding speed of the recording material P in the feeding portion N2 from the first timing t5 to the second timing t3.

Also, in this embodiment, the control means 40 controls the feeding means 15 for one recording material P so that the feeding speed of the recording material P in the feeding portion N2 varies so as for an amount of the deflection as described above becomes to fall within a predetermined range during a predetermined period (a loop control period) from the third timing t1 after when the front end of the recording material P with respect to the direction reaches the feeding portion N2 (almost at the same time in this embodiment) to the fourth timing t2 before the first timing t5 (just before the rear end of the recording material P reaches the transferring portion N1 in this embodiment). Especially in this embodiment, the image forming apparatus 1 includes detection means 21 and 22 for detecting the amount of deflection as described above downstream of the transferring portion N1 and upstream of the feeding portion N2 with respect to the transfer direction of the recording material P. In this embodiment, the control means 40 controls the feeding means 15 in the predetermined period as described above based on results of the detection means 21 and 22 as described above. In this embodiment, the control means 40 controls the feeding means 15 so that the feeding speed of the recording material P at the second timing t5 in the feeding portion N2 becomes faster than an average speed of the recording material P during the predetermined period as described above in the feeding portion N2. In this embodiment, the recording material P is fed from below toward above and from the transferring portion N1 to the feeding portion N2. In this embodiment, the image forming apparatus 1 includes guide members 14 and 20 that guide the recording material P to the feeding portion N2, downstream of the transferring portion N1 and upstream of the feeding portion N2 with respect to the transfer direction of the recording material P, and on the opposite side of the image bearing member 2 with respect to a feeding trajectory of the recording material P. Especially in this embodiment, the feeding means 15 is a fixing device that fixes the toner image transferred to the recording material P onto the recording material P. However, the present disclosure is not limited to this, and another feeding means may be provided between the transferring nip portion N1 and the fixing nip portion N2 in this embodiment to form a deflection that is convex on the opposite side of the photosensitive drum 2.

As described above, according to this embodiment, a rotational speed of the fixing motor M2 is accelerated during a period from the timing t5, when the rear end P2 of the recording material P passes through a center n1 of the transferring nip portion N1 at the latest, to the timing t3, when the rear end P2 of the recording material P is completely separated from the photosensitive drum 2, to accelerate the feeding speed of the recording material P in the fixing nip portion N2. Especially in this embodiment, in this period, a rotational speed of the fixing motor M2 is continuously accelerated to continue accelerating a feeding speed of the recording material P in the fixing nip portion N2. Then, the rear end P2 of the recording material P is quickly moved away from the photosensitive drum 2 by an action of a force due to this acceleration. Thus, the frequency and degree of discharging between the recording material P and the photosensitive drum 2, which starts from the edge portion of the rear end P2 of the recording material P or a sharp burr existed in the rear end P2 of the recording material P, are reduced, and “rear end memory” is suppressed. Also, according to this embodiment, even if a bias applied to the rear end P2 of the recording material P is not sufficiently reduced to a desired weak bias and charge on the rear end P2 of the recording material P becomes excessive, “rear end memory” is suppressed by the effect as described above. In this way, according to this embodiment, a separability of the rear end of the recording material from the image bearing member is improved. Therefore, according to this embodiment, “rear end memory” is suppressed even if conditions, where excessive transfer current flows into the rear end of the recording material, are repeated in recent high-speed image forming apparatuses. That is, according to this embodiment, occurrence of the rear end memory of the image bearing member 2, when the rear end of the recording material P passes through the transferring portion N1, is suppressed regardless of the process speed of the image forming apparatus 1.

### Second Embodiment

Another embodiment of the present disclosure will be described. A basic configuration and operation of the image forming apparatus of this embodiment are the same as those of the image forming apparatus of the embodiment 1. Therefore, in the image forming apparatus of this embodiment, elements having the same or corresponding functions or configurations as those of the image forming apparatus of the embodiment 1 are marked with the same symbol as in the embodiment 1, and detailed explanation is omitted.

In this embodiment, an acceleration mode in the rotational speed control of the fixing motor M2 is different from that of the embodiment 1.

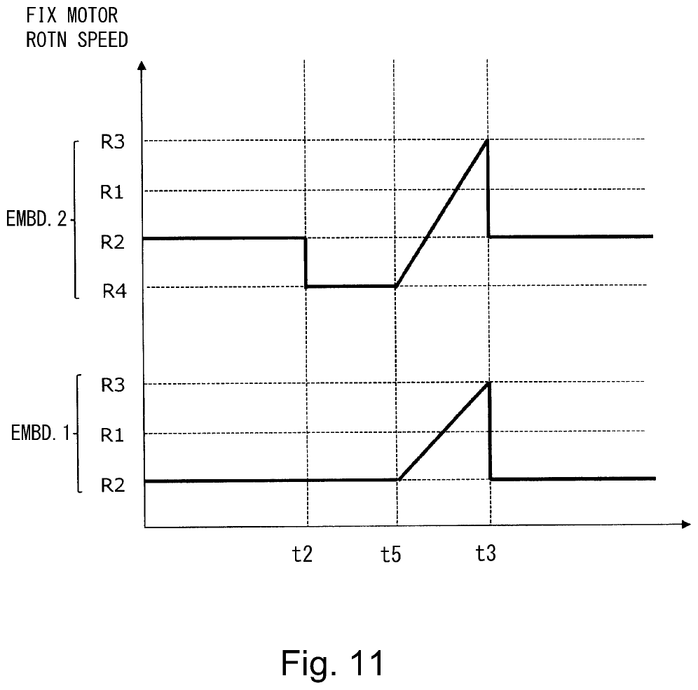

FIG. 11 is a timing chart for comparing and illustrating the rotational speed control of the fixing motor M2 in this embodiment and the embodiment 1. FIG. 11 shows a transition of the rotational speed M1 of the fixing motor M2 in a period from the timing t2 to the timing t3 as described in the embodiment 1.

In this embodiment, after stopping the loop control at the timing t2, the rotational speed of the fixing motor M2 is reduced to a fourth rotational speed R4 during a period from the timing t2 to the timing t5. The fourth rotational speed R4 is slower than the second rotational speed R2. However, it is preferable that the fourth rotational speed R4 is a rotational speed at which the loop amount does not reach Lmax. In this embodiment, subsequently, the acceleration of the fixing motor M2 is subsequently started at the timing t5. The acceleration continues from the timing t5 to the timing t3. In this embodiment, the rotational speed of the fixing motor M2 continues to accelerate without becoming constant speed or decelerating in the middle until it reaches the third rotational speed R3. Thus, in this embodiment, in a period from timing t5 to timing t3, the speed of the fixing motor M2 is increased to a greater extent than the embodiment 1. (That is the acceleration of the fixing motor M2 is more rapidly.)

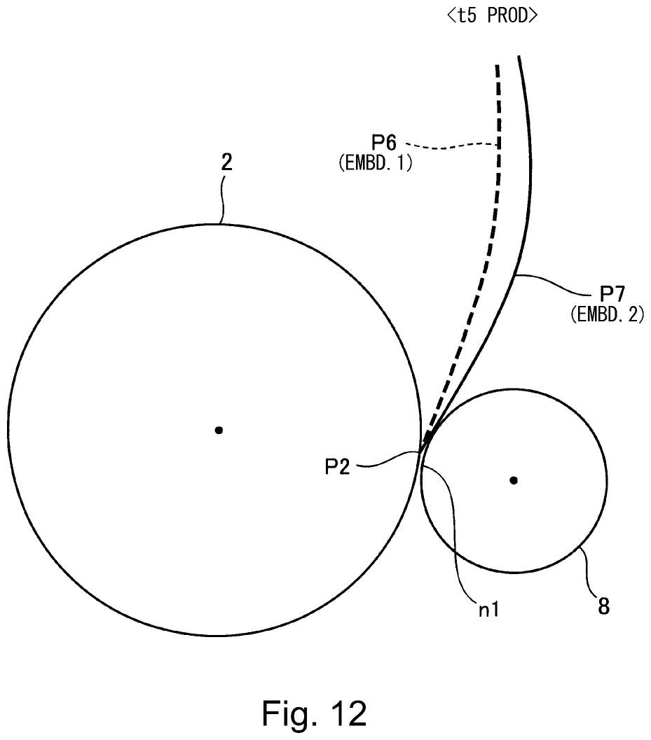

FIG. 12 is a sectional view of a vicinity of the transferring nip portion N1 (sectional surface perpendicular to the rotational axis of the photosensitive drum 2) showing a behavior of the recording material P in this embodiment and the embodiment 1 at the timing t5. The recording material P6 shows a behavior of the recording material P in the embodiment 1 at the timing t5. The recording material P7 shows a behavior of the recording material P in this embodiment at the timing t5. The timing t5 is the timing when the rear end P2 of the recording material P passes through the center n1 of the transferring nip portion N1. An amount of the loop formed downstream of the transferring nip portion N1 with respect to the feeding direction of the recording material P is larger in this example shown with the recording material P7 than in the embodiment 1 shown with the recording material P6. This is because, in this embodiment, after stopping the loop control at timing t2, a rotational speed of the fixing motor M2 has been temporarily decelerated to the fourth rotational speed R4 until the timing t5.

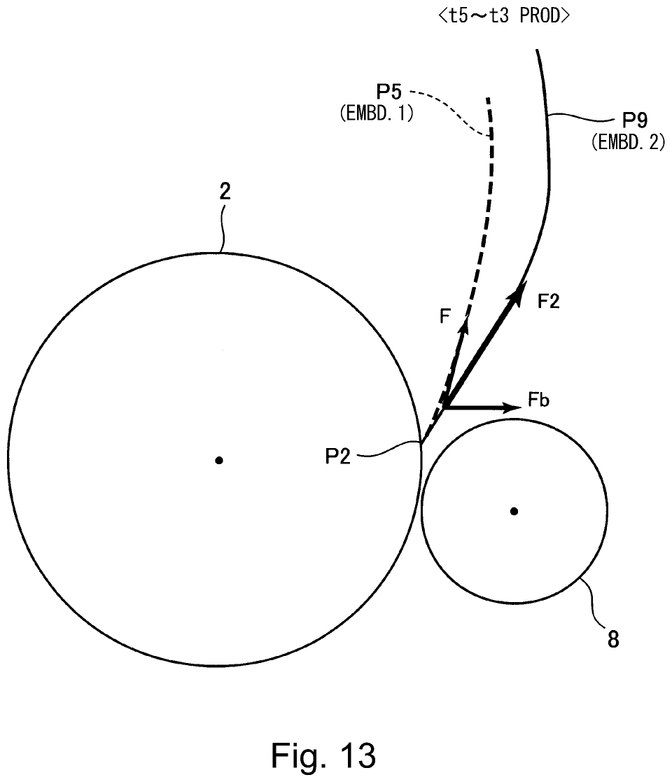

FIG. 13 is a sectional view (sectional surface perpendicular to the rotational axis of the photosensitive drum 2) in a vicinity of the transferring nip portion N1 showing an effect of suppressing “rear end memory” in this embodiment. The recording material P5 shows the behavior of the recording material P in the embodiment 1 in the middle of the period from the timing t5 to the timing t3. The recording material P9 shows a behavior of the recording material P in this embodiment in the middle of the period from the timing t5 to the timing t3. In this embodiment shown in the recording material P9, the loop is gradually resolved by the acceleration of the fixing motor M2, a force F2 caused by the acceleration acts on the recording material P and a component force Fb acts on the rear end P2 of the recording material P in the direction moving away from the photosensitive drum 2. The force F2 caused by the acceleration is larger than the force F in the embodiment 1, which acts on the same principle, because the acceleration of the fixing motor M2 in the period from the timing t5 to the timing t3 is larger in this embodiment. For the same reason, the component force Fb acting in the direction moving away from the photosensitive drum 2 is also larger than the force Fa in the embodiment 1.

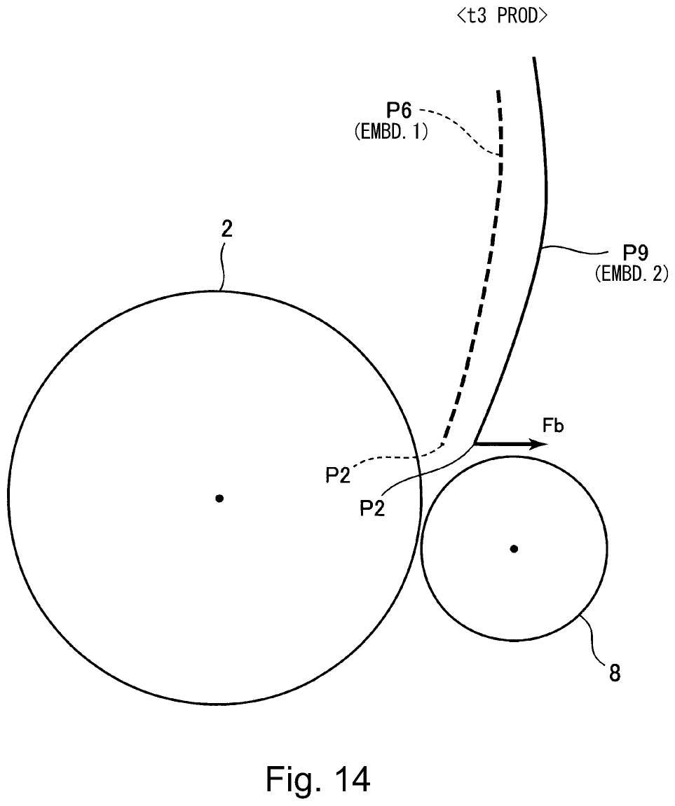

FIG. 14 is a schematic sectional view (sectional surface perpendicular to the rotational axis of the photosensitive drum 2) in a vicinity of the transferring nip portion N1 showing a behavior of the recording material P in this embodiment and the embodiment 1 at the timing t3. In this embodiment shown with the recording material P9, the edge portion of the rear end P2 of the recording material P, which is the starting point of discharging, is moved further away from the photosensitive drum 2 than in the embodiment 1 shown with the recording material P6 caused by the action of the component force Fb as described above. That is, in this embodiment, frequency and degree of discharging between the rear end P2 of the recording material P and the photosensitive drum 2 is further reduced compared to the embodiment 1, so that “rear end memory” is further improved compared to the embodiment 1.

Table 2 shows evaluation results of “rear end memory” in this embodiment, the comparison example 1, the comparison example 2 and the embodiment 1. Occurrence levels and occurrence frequencies of “rear end memory” were evaluated when continuous single-side printing was performed on A4 size plain paper (basis weight 75 g/m²) in a normal humid environment (humidity 60%). Comparison example 1 and comparison example 2 are the same as described in the embodiment 1.

TABLE 2

| | REAR END OF RECORDING | | REAR END OF RECORDING | |
|---|---|---|---|---|
| | MATERIAL (BURR-FREE) | | MATERIAL (BURR) | |
| | OCCURRENCE | OCCURRENCE | OCCURRENCE | OCCURRENCE |
| | FREQUENCY | LEVEL | FREQUENCY | LEVEL |
| COMP. 1 | HIGH | × NOTICEABLE | HIGH | × NOTICEABLE |
| COMP. 2 | LOW | Δ FEW | HIGH | × NOTICEABLE |
| EMBD. 1 | ALMOST NOTHING | ○ | FEW | Δ VERY FEW |
| EMBD. 2 | ALMOST NOTHING | ○ | ALMOST NOTHING | ○ |

In this embodiment, when sharp burrs on the cutting surface are existed at the rear edge P2 of the recording material P, the occurrence frequency of “rear edge memory” is even lower than in the embodiment 1, and the level of occurrence is further improved than in the embodiment 1.

In this embodiment, the control means 40 controls the feeding means 15 by controlling the feeding speed of the recording material P so that the amount of deflection of the recording material P is within a predetermined range during a predetermined period (a loop control period) from the third timing t1 to the fourth timing t2 before the first timing (just before the rear end of the recording material P reaches the transferring portion N1 in this embodiment). And, in this embodiment, the control means 40 controls the feeding means 15, so as to make the feeding speed of the recording material P in the feeding portion N2 slower than the average feeding speed of the recording material P in the feeding portion N2 during the predetermined period as described above, at the fifth timing t2 (in this embodiment, just before the rear end of the recording material P reaches the transferring portion N1) which is after the fourth timing and before the first timing. Especially, in this embodiment, the control means 40 controls the transfer means 15 so as to maintain the transfer speed of the recording material P at the transferring portion N2 from the fifth timing t2 to the first timing t5 at a transfer speed slower than the average transfer speed of the recording material P at the transferring portion N2 in the predetermined period as described above.

As explained above, according to this embodiment, after once decelerating the fixing motor M2 at the timing t2 just before the rear end P2 of the recording material P reaches the transferring nip portion N1 at the latest, and increasing the loop amount of the recording material P, from the timing t5 at which the rear end P2 of the recording material P passes the center n1 of the transferring nip portion N1 at the latest to the timing t3 at which the rear end P2 of the recording material P is completely separated from the photosensitive drum 2, the rotational speed of the fixing motor M2 is accelerated and the feeding speed of the recording material P in the feeding nip portion N2 is rapidly accelerated. Especially, in this embodiment, in this period, the rotational speed of the fixing motor M2 is continuously accelerated to continue accelerating the feeding speed of the recording material P in the fixing nip portion N2. Then, the rear end P2 of the recording material P is quickly moved away from the photosensitive drum 2 by the action of the force due to this acceleration. As a result, frequency and degree of electric discharging between the recording material P and the photosensitive drum 2, which starts from the edge portion of the rear end P2 of the recording material P or sharp burr existing in the rear end P2 of the recording material P, is reduced, and “rear end memory” is further suppressed compared to the embodiment 1. Also, according to this embodiment, even in the case that a bias applied to the rear end P2 of the recording material P cannot be sufficiently reduced to a desired weak bias and a charge of the rear end P2 of the recording material P becomes excessive, “rear end memory” is suppressed by the effect as described above. Thus, according to the present embodiment, a separateness of the rear end of the recording material from the image bearing member is further improved. Therefore, according to this embodiment, “rear end memory” is further suppressed even if conditions where excessive transfer current flows into the rear end of the recording material are repeated in recent high-speed image forming apparatus.

### OTHER EMBODIMENTS

While the present invention has been described with reference to exemplary embodiments, it is to be understood that the invention is not limited to the disclosed exemplary embodiments.

In the embodiments as described above, the fixing device 15 has a configuration which includes an endless belt-shape fixing film 24, a heater 25 contacting an inner surface of a fixing film 24 and a pressure roller 23 forming a fixing nip portion N2 through the fixing film 24 with the heater 25. However, the fixing device is not limited to such a configuration. Typically, the fixing device has a configuration in which a rotatable member driven by a fixing motor has an elastic layer, and the elastic layer undergoes thermal expansion when the rotatable member is heated. For example, the fixing device may have a configuration which have an endless belt-shape fixing film, a heater that is included inside the fixing film and heats an inner surface of the fixing film by radiation heat, a nip portion forming member that contacts the inner surface of the fixing film and a pressure roller that forms a nip portion through the fixing film with the nip portion forming member. For example, the fixing device may also have a configuration which have an endless belt-shape belt which generates heat, a nip portion forming member that contacts an inner surface of the belt and a pressure roller which forms a nip portion through the belt with the nip portion forming member. For example, the fixing device may also have a configuration, so-called thermal roller type, which have a heating roller as a heating rotatable member equipped with a halogen heater inside and a pressure roller as a pressure rotatable member that presses against the heating roller to form a nip portion.

In the embodiment as described above, the timing t2 for stopping the loop control is described the method of calculating a passage timing when the rear end of the recording material P is detected by the registration sensor 13 as a starting point, but the present disclosure is not limited to this method. For example, the timing t2 may be calculated from a passage timing of the front end of the recording material P detected by the registration sensor 13 as a starting point.

In the embodiment as described above, the loop amount of the recording material P is detected by combining a loop detection flag 21 and a loop detection sensor 22 as a loop amount detection means, but the present disclosure is not limited to this method. For example, a loop amount detection means may use an optical sensor to detect the loop amount.

In the embodiment as described above, it is explained as an example that a configuration in which a loop amount is controlled by controlling a rotational speed of the fixing motor M2 based on a detection result of the loop amount, but the present disclosure is not limited to such a configuration. For example, a configuration may be one in which a loop amount is predicted by predicting a thermal expansion of the fixing member based on a heating history (temperature history, use history) of the fixing device, and a rotational speed of the fixing motor M2 is controlled based on the result to control the loop amount.

In order to achieve the effects explained in the embodiment as described above, it is necessary to accelerate the fixing motor M2 during the predetermined period as described above, and typically it is desirable to continue to accelerate it practically. However, a rotational speed of the fixing motor M2 may become constant speed or decelerate for a small period of time that does not affect a behavior of the recording material P. It is not problem as long as they do not affect a behavior of the recording material P.

In the embodiment as described above, the image forming apparatus 1 is a monochrome image forming apparatus using a process cartridge 18, but the present disclosure is not limited to this type. For example, the image forming apparatus may be an image forming apparatus that uses an intermediary transfer belt or a feeding belt.

For example, a color image forming apparatus of the intermediary transfer type as follows is well known. That is, this image forming apparatus includes an intermediate transfer member as a second image bearing member that feeds a toner image that has been primary transferred from a photosensitive member as a first image bearing member for secondary transfer to a recording material. Especially, in a tandem-type image forming apparatus, several photosensitive members and means for forming a toner image on the photosensitive members are provided, and toner images of several colors are superimposed from several photosensitive embers onto the intermediate transfer member for primary transfer. As an intermediary transfer member, an intermediary transfer belt consisting of an endless belt stretched over a several tensioning rollers is widely used. An intermediary transfer belt rotates (circulating movement) when a driving roller, which is one of several tensioning rollers, is driven to rotate. Secondary transfer is performed by applying a secondary transfer bias to an inner rollers which is one of several tensioning rollers for an intermediary transfer belt, or an outer roller which contacts an inner roller through the intermediary transfer belt. In such an image forming apparatus, a secondary transferring nip portion (secondary transferring portion), which is a contact portion between an intermediary transfer belt and an outer roller, is formed by the inner roller and the outer roller which contacts the inner roller through the intermediary transfer belt. In such an image forming apparatus, the present disclosure can be applied for a secondary transferring nip portion if a configuration is such that a loop that is convex on the opposite side of an intermediary transfer belt (inner roller) is formed on downstream side of the feeding direction of the recording material from the secondary transferring nip portion when the rear end of the recording material passes through the secondary transferring nip portion. In this case, the timing t3 in the embodiment as described above can be set by regarding an inner roller as a photosensitive drum in the embodiment described above. Thus, a separability from an image bearing member (intermediary transfer belt) of a rear end of a recording material is also improved in the image forming apparatus with such a configuration.

For example, in the embodiment as described above, the transferring roller is constituted to contact the image bearing member directly, but a transferring roller may contact an image bearing member through a feeding belt as a transfer rotatable member stretched between the transferring roller and another roller. In this case, the present disclosure can also be applied to a configuration in which a loop that is convex on the opposite side of the image bearing member is formed on downstream side of the feeding direction of the recording material from the transferring nip portion when the rear end of the recording material passes through the transferring nip portion. Thus, a separability from an image bearing member of a rear end of a recording material is also improved in the image forming apparatus with such a configuration.

In the embodiment as described above, the image forming apparatus controls the bias applied to the rear end of the recording material to be a weak bias, but the present disclosure can be applied to a configuration in which this control is not performed, and the same effect of improved separability (suppression of rear end memory) as in the embodiment as described above is achieved.

The present disclosure is also equally applicable to image formation without a margin area of at least one of a front end, a back end, a right end and a left end of a recording material.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-100557 filed on Jun. 9, 2020, which is hereby incorporated by reference herein in its entirety.

What is claimed is:

1. An image forming apparatus comprising:
a rotatable image bearing member configured to bear a toner image;
a rotatable transfer member configured to form a transfer portion for transferring the toner image from said image bearing member to a recording material in contact with said image bearing member, and to nip the recording material between itself and said image bearing member at said transfer member;
a feeding unit provided with a feeding portion configured to nip and feed the recording member in a downstream of said transfer portion with respect to a feeding direction of the recording material, said feeding unit being capable of feeding the recording material nipped by both said transfer portion and said transfer portion in a state in which a deflection of the recording material convexly protruding toward an opposite side of said image bearing member is formed between said transfer portion and said feeding portion; and
a control portion configured to control a feeding speed of the recording material at said feeding portion of said feeding unit,
wherein when a first timing is a timing during when a rear end of the recording material with respect to the feeding direction passes through said transferring portion and a second timing is a timing when the rear end of the recording material is separated from said image bearing member after passing through said transferring portion, said control portion controls said feeding unit for one recording material so that a feeding speed of the recording material at the second timing in said feeding portion becomes faster than that of at the first timing in said feeding portion.

2. An image forming apparatus according to claim 1, wherein the first timing is a timing when the rear end of the recording material with respect to the feeding direction passes through a center of said transferring portion.

3. An image forming apparatus according to claim 1, wherein the second timing is a timing after the lapse of time taken by said image bearing member to move by the same distance as a radius of said image bearing member with a cylindrical shape at a peripheral speed of said image bearing member from a timing when the rear end of the recording material with respect to the feeding direction passes through a center of said transferring portion.

4. An image forming apparatus according to claim 1, wherein said control portion controls said feeding unit for one recording material so that the feeding speed of the recording material in said feeding portion continuously increases from the first timing to the second timing.

5. An image forming apparatus according to claim 1, wherein said control portion controls said feeding unit for one recording material so that the feeding speed of the recording material in said feeding portion varies so as for an amount of the deflection to fall within a predetermine range during a predetermined period from a third timing after when a leading end of the recording material with respect to the feeding direction reaches said transferring portion to a fourth timing before the first timing.

6. An image forming apparatus according to claim 5, further comprising a detecting portion provided downstream of said transferring portion and upstream of said feeding portion with respect to the feeding direction of the recording material and configured to detect the amount of the deflection,
wherein said control portion controls said feeding unit during the predetermined period based on a result of said detecting portion.

7. An image forming apparatus according to claim 5, wherein said control portion controls said feeding unit so that the feeding speed of the recording material at the second timing in said feeding portion becomes faster than an average speed of the recording material during the predetermined period in said feeding portion.

8. An image forming apparatus according to claim 5, wherein said control portion controls said feeding unit so that the feeding speed of the recording material at a fifth timing after the fourth timing and before the first timing in said feeding portion becomes slower than an average speed of the recording material during the predetermined period in said feeding portion.

9. An image forming apparatus according to claim 8, wherein said control portion controls said feeding unit so that the feeding speed of the recording material from the fifth timing to the first timing in said feeding portion is maintained to at a feeding speed slower than the average speed of the recording material during the predetermined period in said feeding portion.

10. An image forming apparatus according to claim 1, wherein the recording material is fed from below toward above and from said transferring portion to said feeding portion.

11. An image forming apparatus according to claim 1, further comprising a guide member configured to wherein said control portion controls said feeding unit so that the feeding speed of the recording material from the fifth timing to the first timing in said feeding portion.

12. An image forming apparatus according to claim 1, wherein said feeding unit includes a fixing unit configured to fix the toner image transferred to the recording material onto the recording material.
